(19) United States
(12) Patent Application Publication
(10) Pub. No.: US 2004/0042814 A1
(43) Pub. Date: Mar. 4, 2004

(54) Electric apparatus and heating device with variable circuit and image forming apparatus using such device

(75) Inventor: Takashi Yamada, Nukata-gun (JP)

Correspondence Address: MORRISON & FOERSTER LLP, 1650 TYSONS BOULEVARD, SUITE 300, MCLEAN, VA, 22102, US

(73) Assignee: Minolta Company, Ltd., Osaka-shi (JP)

(21) Appl. No.: 10/649,838

(22) Filed: Aug. 28, 2003

(30) Foreign Application Priority Data
Aug. 29, 2002 (JP) 2002-250231

(51) Int. Cl. G03G 15/00

(52) U.S. Cl. 399/90

(57) ABSTRACT

A circuit board having a heating source included in the fixing device, which is incorporated in an image forming apparatus, may be mounted in multiple different ways to the power supply unit for the device. The circuit board includes multiple terminals such that different terminals may be connected to the power supply unit depending on the mounting orientation of the circuit board to the power supply unit. Depending on such mounting orientation, the current path in the circuit board changes. Consequently, different power supply voltages are accommodated and alternation between different power consumption levels is carried out simply by changing the mounting orientation of the single circuit board to the power supply unit.

The present application claims priority to Japanese Patent Application No. 2002-250231 filed Aug. 29, 2002, the entire content of which is hereby incorporated by reference.

### BACKGROUND OF THE INVENTION

1. Field of the Invention

The present invention relates to an electric apparatus, a heating device and a fixing device having a variable circuit.

2. Description of the Related Art

Image forming apparatuses, such as copying machines and printers, that form an image by thermally fixing toner onto a recording sheet using a fixing device are available with various image forming speeds. A different image forming speed involves different optimal conditions for the heating device, such as the fixing temperature. Therefore, depending on the model in which the fixing device will be incorporated, components that generate different amounts of heat must be incorporated in the heating element, such as a heat generator or induction coil, that comprises the heat source for the fixing device, together with the circuit that supplies power to the heating element. Accordingly, a number of heating elements corresponding to the number of models are needed, which leads to the problem of increased cost due to the increased number of different components.

In addition, even as between two models having the same image forming speed and other performance specifications, the number of components may be large in order to accommodate the power supply voltage of the country to which the model is shipped. In other words, the commercial power supply voltage varies from region to region. For example, it is 100V in Japan, 120V in the U.S., and 220-240V in Europe. In order to accommodate these different power supply voltages in the various regions or countries, different components that correspond to the various voltages are used in the conventional art, which leads to the problem of increased cost due to the increased number of components.

This increase in the number of components in order to accommodate models having different performance specifications or different shipment destinations is not limited to copying machines, printers or the like, but also applies to cooking apparatuses and heating apparatuses that use a heating element such as a heat generator or induction coil.

In connection with the problems identified above, a technology that allows switching between compatible power supply voltages via a switch has been proposed in order to accommodate various power supply voltages using one device. For example, Japanese Laid-Open Patent Application 2000-197268 discloses a technology for switching between compatible power supply voltages by changing the transformer connection. Japanese Laid-Open Utility Model Application H5-90879 discloses a technology that changes the output by switching between a series connection and a parallel connection for a ceramic heater via a switch. However, even where such a switch is included, circuits for the different voltages are still needed, which leads to the problem that the circuit construction becomes complex.

### SUMMARY OF THE INVENTION

A main object of the present invention is to provide an electric apparatus that can easily accommodate various different performance specifications or various different power supply voltages for different shipment destinations using a single component.

Another object of the present invention is to provide an image forming apparatus that can easily accommodate various image forming speeds or various different power supply voltages for different shipment destinations using a single fixing device.

In order to attain these and other objects, according to one aspect of the present invention, an electric apparatus includes a power supply unit that has terminals to supply power to a circuit board, and a circuit board that can be mounted to the power supply unit using at least two different mounting orientations and can change the current path depending on the orientation with which it is mounted.

In this electric apparatus, the power consumed by the circuit board can be changed depending on the direction in which it is mounted to the power supply unit. Conversely, by changing the orientation in which the circuit board is mounted to the power supply unit based on the voltage impressed by the power supply unit to the circuit board, the power consumed by the circuit board can be maintained at a constant level.

In addition, it is preferred that the circuit board include multiple connection points at which the circuit board is connected to the power supply unit, as well as two circuit elements that are installed between the connection points, such that the connection between the two circuit elements may be switched between series connection and parallel connection by changing the orientation in which the circuit board is mounted to the power supply unit.

It is also preferred that the circuit board be mountable to the power supply unit in two different orientations whereby one such orientation has a 180° rotational relationship to the other orientation, such orientation being obtained by rotating the circuit board relative to an axis perpendicular to the surface thereof. It is also acceptable if one such orientation has a 180° rotational relationship to the other orientation, such orientation being obtained by rotating the circuit board relative to an axis parallel to the surface thereof.

According to another aspect of the present invention, an image forming apparatus includes an image forming system that forms toner images on recording sheets, and a fixing device that heats and fuses each toner image formed on a sheet by the image forming system, wherein the fixing device includes a power supply unit that has terminals for supplying power to a circuit board, and a circuit board that has a heater and that can be mounted to the power supply unit in at least two different orientations such that the current path to the heater can be changed depending on the mounting orientation.

The invention itself, together with further objects and attendant advantages, will best be understood by reference to the following detailed description taken in conjunction with the accompanying drawings.

### BRIEF DESCRIPTION OF THE DRAWINGS

FIG. 1 is a schematic diagram showing a belt-type fixing device in which the present invention is applied;

FIG. 2 shows a circuit board pertaining to a first embodiment of the present invention;

FIG. 3 shows the circuit board of the first embodiment when it is mounted in a first mounting orientation;

FIG. 4 shows the circuit board of the first embodiment when it is mounted in a second mounting orientation;

FIG. 5 shows a circuit board pertaining to a second embodiment of the present invention;

FIG. 6 shows the circuit board of the second embodiment when it is mounted in a first mounting orientation;

FIG. 7 is the circuit board of the second embodiment when it is mounted in a second mounting orientation;

FIG. 8 shows the circuit board of a third embodiment of the present invention when it is mounted in a first mounting orientation;

FIG. 9 is the circuit board of the third embodiment when it is mounted in a second mounting orientation;

FIG. 10 shows the circuit board of a fourth embodiment of the present invention when it is mounted in a first mounting orientation;

FIG. 11 is the circuit board of the fourth embodiment when it is mounted in a second mounting orientation;

FIG. 12 shows the circuit board of a fifth embodiment of the present invention when it is mounted in a first mounting orientation;

FIG. 13 is the circuit board of the fifth embodiment when it is mounted in a second mounting orientation;

FIG. 14 is a schematic diagram showing a belt-type fixing device using the induction heating method in which the present invention is applied;

FIG. 15 shows the circuit board of a sixth embodiment of the present invention when it is mounted in a first mounting orientation;

FIG. 16 is the circuit board of the sixth embodiment when it is mounted in a second mounting orientation;

FIG. 17 is a schematic diagram showing a heat roller-type fixing device in which the present invention is applied; and

FIG. 18 is a schematic diagram showing the construction of a printer in which the present invention is applied.

In the following description, like parts are designated by like reference numbers throughout the several drawings.

### DETAILED DESCRIPTION OF THE PREFERRED EMBODIMENTS

The electric apparatus of the present invention may comprise any electric apparatus that must accommodate multiple output settings or multiple power supply specifications. Such electric apparatuses include image forming apparatuses such as copying machines or printers that perform image formation by forming a toner image on a sheet of recording paper or transparency and fixing it thereon. The present invention is particularly effective if applied in a fixing device that is incorporated in an image forming apparatus and is used to thermally fix the toner to the sheet.

A fixing device comprising an electric apparatus embodying the present invention is described below in specific terms with reference to the accompanying drawings.

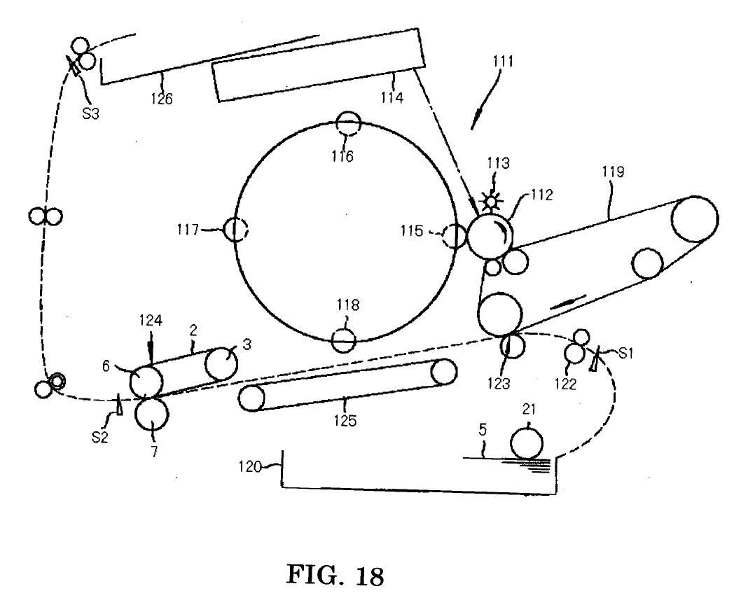

FIG. 18 shows the schematic construction of an electrophotographic full-color printer in which the present invention is applied. The printer 111 shown in FIG. 18 includes a photoreceptor drum 112 that serves as an image carrier, as well as a laser generator 114, and around the photoreceptor drum 112 that rotates in the direction of the arrow are disposed a charger 113 that charges the external circumferential surface of the photoreceptor drum 112, a developing unit that includes first through fourth developing devices 115, 116, 117 and 118, and a transfer belt 119. The laser generator 114 drives a semi-conductor laser in response to the level of the image signal sent from a computer or the like. Laser light is emitted toward the photoreceptor drum 112 via a scanning optical system. The electrostatic latent image formed on the photoreceptor drum 112 based on the irradiation of laser light is developed into a yellow toner image by the first developing device 115. This yellow toner image is transferred onto the transfer belt 119 that revolves in the direction of the arrow. The next electrostatic latent image formed on the photoreceptor drum 112 is developed into a magenta toner image by the second developing device 116, and this magenta toner image is superimposed on the yellow toner image on the transfer belt 119. Similarly, the next electrostatic latent image formed on the photoreceptor drum 112 is developed into a cyan toner image by the third developing device 117, and a full-color toner image is created when this cyan toner image is superimposed on the toner image that is already on the transfer belt 119. The fourth developing device 118 houses black toner. When monochrome printing is designated, the electrostatic latent image on the photoreceptor drum 112 is developed by this fourth developing device 118.

At the same time, the sheets 5 housed in the paper supply cassette 120 are supplied one sheet at a time by a paper supply roller 121, and are conveyed by a timing roller 22 toward the transfer area 123. The full-color toner image on the transfer belt 119 is transferred onto a sheet 5 in this transfer area 123. The sheet 5 that has undergone image transfer is conveyed toward the fixing device 124 by a conveyance belt 125. The unfixed toner that has been transferred onto the sheet 5 is fused and fixed onto the sheet 5 by the fixing device 124. The sheet 5 onto which the toner has been fixed is ejected onto an eject tray 126. The fixing device 124 of this embodiment is a belt-type fixing device, and the construction thereof is described below.

Multiple sensors S1, S2 and S3 that detect the sheet 5 are disposed in the sheet conveyance path, and control timing for the various components in the printer is coordinated based on the signals indicating detection of the leading edge and/or trailing edge of the sheet 5 by the sensors S1, S2 and S3.

In the description of this embodiment, among the various constituent elements described above, the components involved in the formation of the unfixed toner image onto the sheet, except for the fixing device, are collectively termed the image forming system.

The fixing device in which the present invention is applied is described in detail below.

(Embodiment 1)

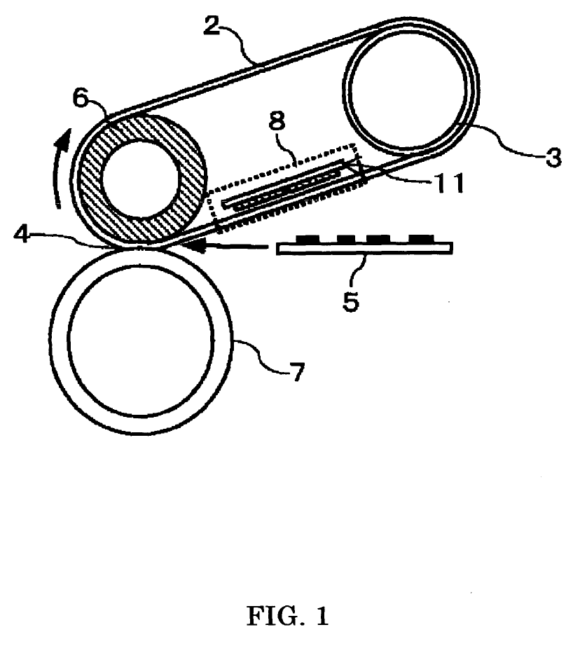

FIG. 1 is a schematic diagram showing a belt-type fixing device used in the image forming apparatus in which the present invention is applied. A fixing belt 2 is wrapped around a tension roller 3 and a drive roller 6 that is driven by a motor. A pressure roller 7 is pressed onto the external circumferential surface of the fixing belt 2 such that pressure is exerted in the direction of the axis of the drive roller 6, thereby creating a nip 4.

The fixing belt 2 is a thin and preferably seamless belt formed of carbon steel, stainless steel, nickel or heat-resistant resin or the like, and has on the surface thereof a heat-resistant elastic layer (silicone rubber, for example) and/or heat-resistant release layer (fluorocarbon resin), for example.

The drive roller and pressure roller 7 each comprise a cylindrical or pillar-shaped metal core and an elastic layer that surrounds the core.

A circuit board 11 that incorporates electric wiring including a heating element is disposed inside the fixing belt 2. The circuit board 11 is secured to power supply units 8 disposed in the fixing device structure. A heater is disposed on the circuit board 11. The heater generates heat when energized, and is capable of heating the fixing belt 2.

The fixing belt 2 revolves as the drive roller 6 rotates in the direction of the arrow, and the pressure roller 7 also rotates accordingly. When the sheet 5 carrying unfixed toner passes through the nip 4 thereby receiving pressure and heat, the toner is fixed onto the sheet 5.

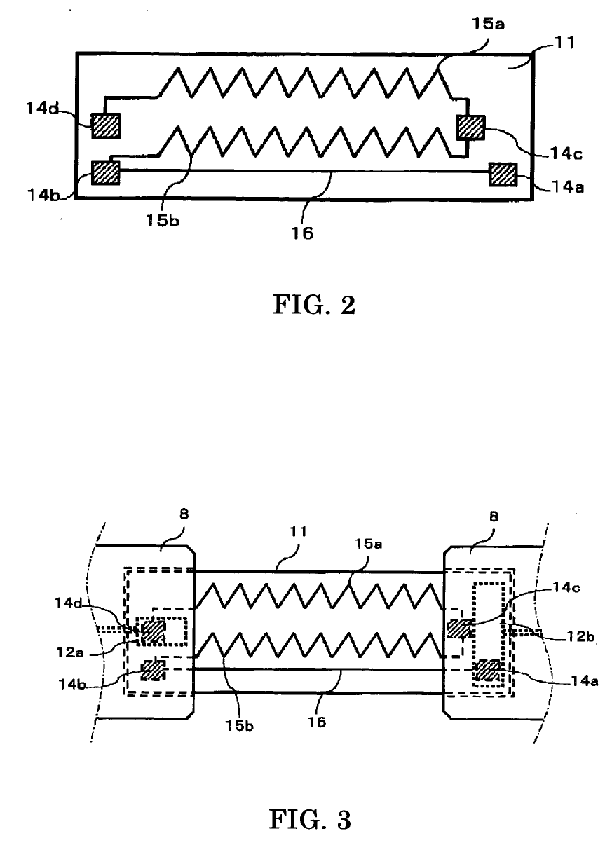

FIG. 2 shows the circuit board 11 in this embodiment. The vertical direction from top to bottom in the figure is the direction in which the sheet 5 is conveyed. The circuit board 11 is essentially rectangular. Contact points 14a, 14b, 14c and 14d used to supply power to the electric circuit on the board are disposed on the circuit board 11. The contact points 14b and 14d are located near one of the shorter sides of the circuit board 11. The contact point 14b is located near a corner of the circuit board 11, while the contact point 14d is located near the center of the shorter side.

The contact points 14a and 14c are located near the other shorter side. The contact point 14a is located near a corner of the circuit board 11. The contact point 14c is located near the center of the shorter side but inward from the shorter side by as much as one contact point. In other words, the contact points 14a and 14c are not aligned along either the shorter side or the longer sides.

The contact points 14a and 14b are connected by a lead wire 16. A heating resistor 15b is connected between the contact points 14b and 14c, and a heating resistor 15a is connected between the contact points 14c and 14d. Consequently, the lead wire 16 and the heating resistors 15a and 15b are connected in series via the contact points 14b and 14c, while they form a zigzag that reverses direction at the contact points 14b and 14c. The heating resistors 15a and 15b function together as a heater, which comprises the heating source for the fixing device.

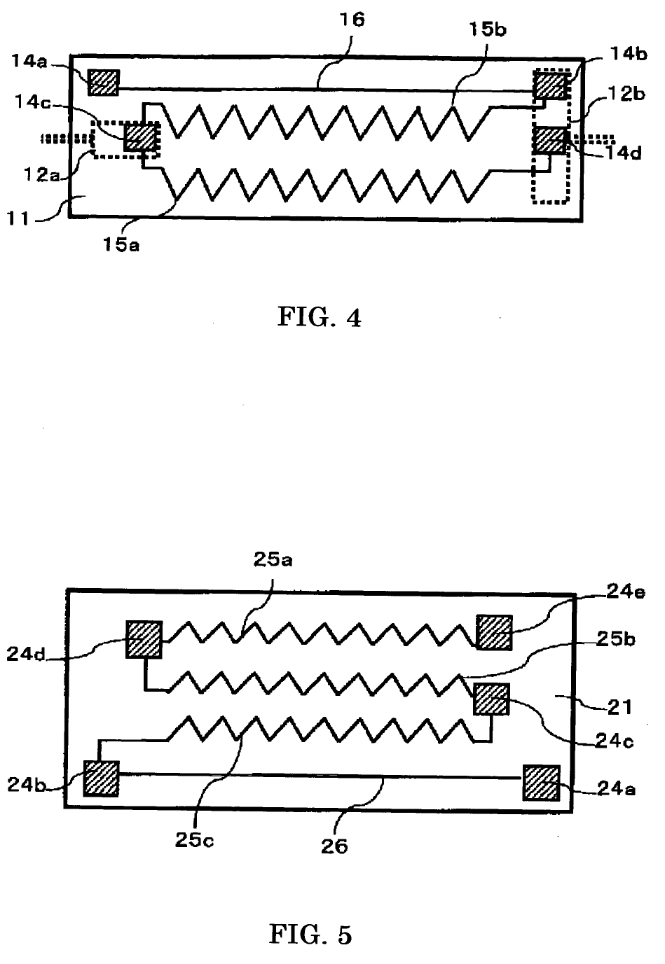

FIGS. 3 and 4 show two mounting orientations for the circuit board 11 having the above-described construction and the power supply units 8.

The power supply units 8 have terminals 12a and 12b, respectively, which supply power to the circuit board 11 at positions that face the contact points near the shorter sides of the circuit board 11. Consequently, when the circuit board 11 is connected to the power supply units 8, the contact points on the circuit board 11 and the terminals of the power supply units 8 become connected.

The terminals 12a and 12b have different configurations. The terminal 12a has a rectangular configuration that is aligned with the longer sides of the circuit board 11. On the other hand, the terminal 12b has a rectangular configuration that is aligned with the shorter sides of the circuit board 11.

FIG. 3 shows the connection state in which the circuit board 11 is mounted to the power supply units 8 in a first mounting orientation. In this state shown in FIG. 3, the terminal 12a located near the shorter side close to which the contact points 14b and 14d are disposed is in contact with the contact point 14d only because it is located closer to the center of the circuit board 11. The terminal 12b is not in contact with the contact point 14c, which is located toward the center of the circuit board 11, but is in contact with the contact point 14a only because the terminal 12b is disposed such that it comes into contact with the outer area of the circuit board 11. In this state using the first mounting orientation, the heating resistors 15a and 15b are connected in series.

FIG. 4 shows the connection state using a second mounting orientation in which the circuit board 11 shown FIG. 3 using the first mounting orientation is rotated 180° relative to an axis perpendicular to the wiring surface. It shows a state in which the circuit board 11 is connected to the same power supply units 8 (only the terminals are shown) shown in FIG. 3. In other words, the circuit board 11 faces the same direction in the first and second connection states, but the connection between the shorter sides of the circuit board 11 and the power supply units 8 is opposite in the two connection states.

In the connection state using the second mounting orientation, the terminal 12a faces the shorter side close to which the contact points 14a and 14c are disposed, and is in contact only with the contact point 14c located toward the center of the shorter side of the circuit board 11. On the other hand, the terminal 12b is in contact with both contact points 14b and 14d. Consequently, the heating resistors 15a and 15b are connected in parallel.

By appropriately setting the arrangement of the contact points on the circuit board 11 and the configurations of the terminals on the power supply units 8 as described above, the connection configuration of the heating resistors may be alternated between a series connection and a parallel connection depending on the mounting orientation of the circuit board.

The resistance is set at 20 Ω for both heating resistors 15a and 15b in this embodiment. Therefore, the combined resistance for the entire board is 40 Ω in the case of a series connection (FIG. 3), and 10 Ω in the case of a parallel connection (FIG. 4). Where the power supply voltage is 100V, the combined power consumption by the heating resistors 15a and 15b, i.e., the heater output, becomes 250W when the first mounting orientation is used (FIG. 3) in which the heating resistors 15a and 15b are connected in series, and 1,000W for the second mounting orientation (FIG. 4) in which the heating resistors 15a and 15b are connected in parallel. The heater output may be changed simply by changing the mounting orientation of the circuit board 11 to the power supply units 8 as described above, and therefore one set of components can accommodate two different sets of product specifications.

In addition, by changing the mounting orientation of the circuit board 11 to the power supply units 8 depending on the power supply voltage, the same heater output can be obtained regardless of the power supply voltage. Where the power supply voltage is 200V, the heater output becomes 1,000W by connecting the heating resistors 15a and 15b in series (FIG. 3). On the other hand, where the power supply voltage is 100V, the same heater output of 1,000W can be obtained by connecting the heating resistors 15a and 15b in parallel (FIG. 4). By using the circuit board 11 of this embodiment as described above, one set of components can accommodate two different power supply voltages.

(Embodiment 2)

A second embodiment of the present invention is described below. The first embodiment described a construction capable of changing the resistance on the entire circuit board by at least a factor of four by alternating the connection of the two heating resistors between a series connection and a parallel connection. This embodiment describes a construction in which the resistance is changed by less than a factor of four depending on the orientation of mounting.

FIG. 5 shows the circuit board of the second embodiment. Contact points 24b and 24d are disposed near one of the shorter sides of a rectangular circuit board 21. Of these contact points, the contact point 24b is located closer to a corner of the circuit board 21. The contact point 24d is located closer to the longer side opposite from the contact point 24b, and the contact points 24b and 24d are not aligned along either the shorter sides or the longer sides.

Contact points 24a, 24c and 24e are disposed near the other shorter side. Of these contact points, the contact point 24a is located closer to another corner of the longer side near which the contact point 24b is also located. The contact point 24c is located near the center of the shorter side, and the contact point 24e is located closer to the longer side opposite from the contact point 24a. The contact points 24c and 24e are arranged such that they are aligned along the shorter side. The contact points 24c and 24e are not aligned with the contact point 24a along either the shorter sides or the longer sides of the circuit board 21.

The contact points 24a and 24b are connected by a lead wire 26. Heating resistors 25c, 25b and 25a are disposed between the contact points 24b and 24c, the contact points 24c and 24d, and the 24d and 24e, respectively. Consequently, the heating resistors 25a, 25b and 25c and the lead wire 26 are connected in series via the contact points. The lead wire 26 and heating resistors reverse direction at the contact points 24b, 24c and 24d, creating an overall zigzag configuration. The heating resistors 25a, 25b and 25c function together as a heater comprising the heating source of the fixing device.

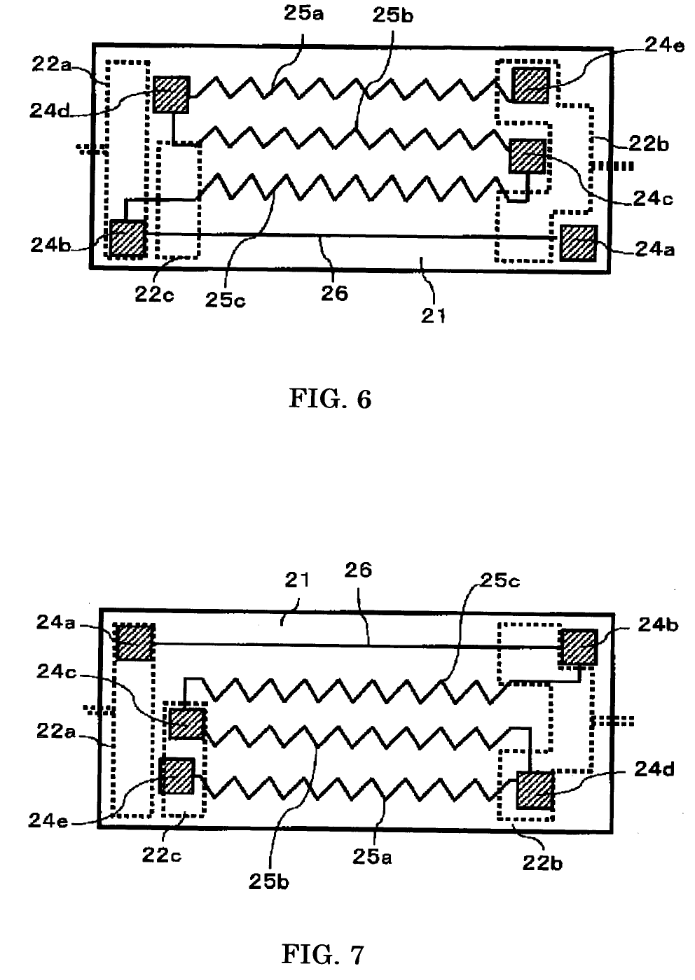

FIGS. 6 and 7 show different states in which the terminals are connected to the contact points via different mounting orientations using the circuit board having the construction described above.

FIG. 6 shows the connection state in which the circuit board 21 is mounted to the power supply units (only the terminals are shown) using a first mounting orientation. As in the above-described first embodiment, by connecting the circuit board 21 to the power supply units, the contact points on the circuit board 21 and the terminals become connected.

Terminals 22a and 22b for power supply and a terminal 22c for contact point connection are disposed on the power supply units. The terminal 22a is disposed such that it faces the contact point near a shorter side of the circuit board 21, and has a rectangular configuration that extends parallel to such shorter side over essentially the entire length thereof. The terminal 22c for contact point connection is disposed in the same shorter side area as the terminal 22a, and has a rectangular configuration that parallel along such shorter side of the circuit board 21.

On the other hand, the terminal 22b is disposed such that it comes into contact with the shorter side area opposite from the terminal 22a. The terminal 22b has a two-terminal configuration such that it can be connected with the contact points located near either longer side of the circuit board 21.

FIG. 6 shows the connection state using the first mounting orientation. In this state, the terminal 22a is in contact with the contact point 24b only, which is located in the same shorter side area as the contact point 24d but is closer to the shorter side. The terminal 22c is not in contact with any of the contact points. The terminal 22b is in contact with the contact point 24e only. In this state, the heating resistors 25a, 25b and 25c are connected in series.

FIG. 7 shows the connection state using a second mounting orientation. In this state, the circuit board 21 mounted using the first mounting orientation is rotated 180° relative to an axis perpendicular to the wiring surface, and is connected to the same power supply units as in FIG. 6 above. In other words, the circuit board 21 faces the same direction in the first and second connection states, but the connection between the shorter side areas of the circuit board 21 and the power supply units is the opposite in the two connection states.

In the connection state using the second mounting orientation, the terminal 22a is connected to the contact point 24a located closer to a shorter side of the circuit board 21. The terminal 22c for contact point connection is connected to the contact points 24c and 24e. At the same time, the terminal 22b is connected to the contact point 24d only. When the contact points and terminals are connected in this way, the heating resistors 25a and 25b become connected in parallel, and the heating resistor 25c is connected in series to them.

In this embodiment, because the resistances of the heating resistors 25a, 25b and 25c are 2 Ω, 3.7 Ω and 8.7 Ω, respectively, the combined resistance for the entire circuit board is 14.4 Ω when the first mounting orientation is used (FIG. 6), and is 10 Ω when the second mounting orientation is used (FIG. 7).

Where the power supply is 100V, the heater output combining the heating resistors 25a, 25b and 25c becomes 694W for the first mounting orientation (FIG. 6). It is 1,000W for the second mounting orientation (FIG. 7). As described above, and as in the embodiment 1 above, two different specifications requiring different heater outputs can be accommodated by changing the mounting orientation of the circuit board in the second embodiment as well.

In addition, if the first mounting orientation (FIG. 6) is used when the power supply is 120V, and the second mounting orientation (FIG. 7) is used when the power supply is 100V, the same heater output of 1,000W can be obtained for both mounting orientations. The present invention can accommodate situations where the same output is needed for different power supply voltages by changing the mounting orientation of the circuit board.

As described above, the embodiment 2 constitutes a part comprising two heating resistors that can change the combined resistance by at least a factor of four by alternating between series connection and parallel connection therebetween, and a heating resistor that is connected to the above resistors in series. Consequently, a change in resistance by a factor of four or less can be obtained.

(Embodiment 3)

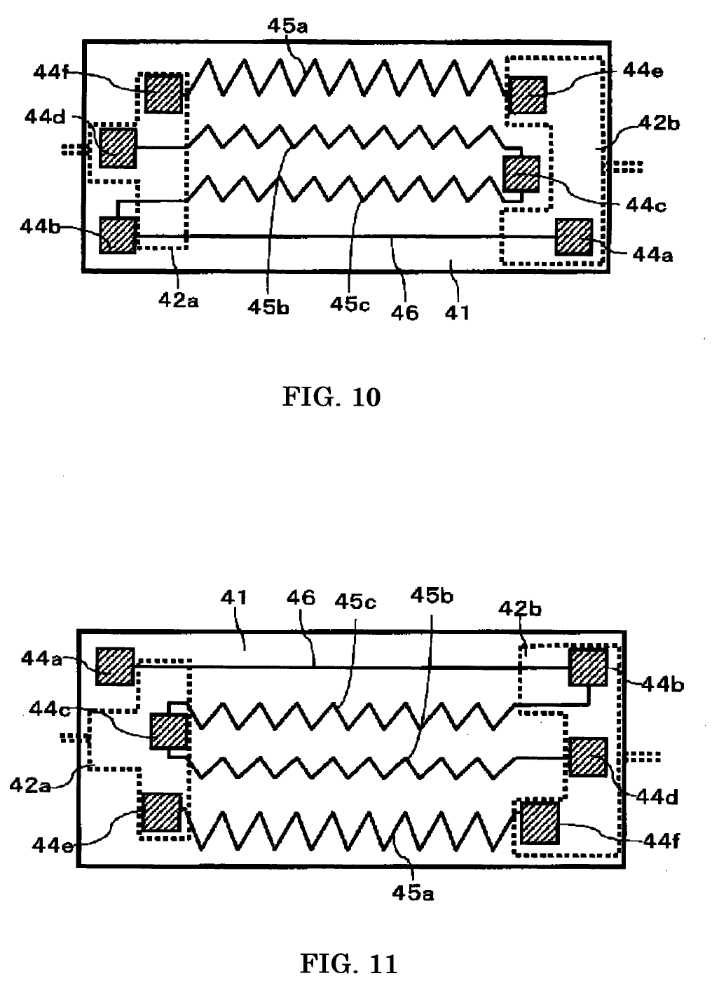

FIGS. 9 and 10 show a third embodiment. In the circuit board of this embodiment, the connection configuration for three heating resistors can be alternated between a series connection and a parallel connection by changing the mounting orientation of the circuit board. Consequently, the resistance can be changed by a factor of nine or higher. While such a large change in resistance is possible when two heating resistors are used as in the first embodiment, the resistances of the two heating resistors become large. In other words, the difference in generated heat between the heating resistors increases. For example, where the resistance for the entire board is to be changed by a factor of nine by changing the mounting orientation of the circuit board, two heating resistors, one of which has a resistance nine times larger than that of the other, must be used in the case of the construction of the first embodiment. However, in this embodiment, three heating resistors having the same resistance may be used, which ensures more consistent heating over a wide range. The construction of this embodiment is described below.

Contact points 34b and 34d are disposed near one shorter side of a rectangular circuit board 31. The contact point 34d is located near a corner of the circuit board 31. On the other hand, the contact point 34b is located such that it is aligned with the contact point 34d along the shorter side. Contact points 34a and 34c are disposed near the other shorter side. The contact point 34a is located near the longer side opposite from the longer side close to which the contact point 34d is located. The contact point 34c is located near the center along the shorter side [close to which the contact point 34a is located]. Heating resistors 35a, 35b and 35c are disposed between the contact points 34a and 34b, the contact points 34b and 34c, and the contact points 34c and 34d, respectively, and these heating resistors are connected in series via the contact points.

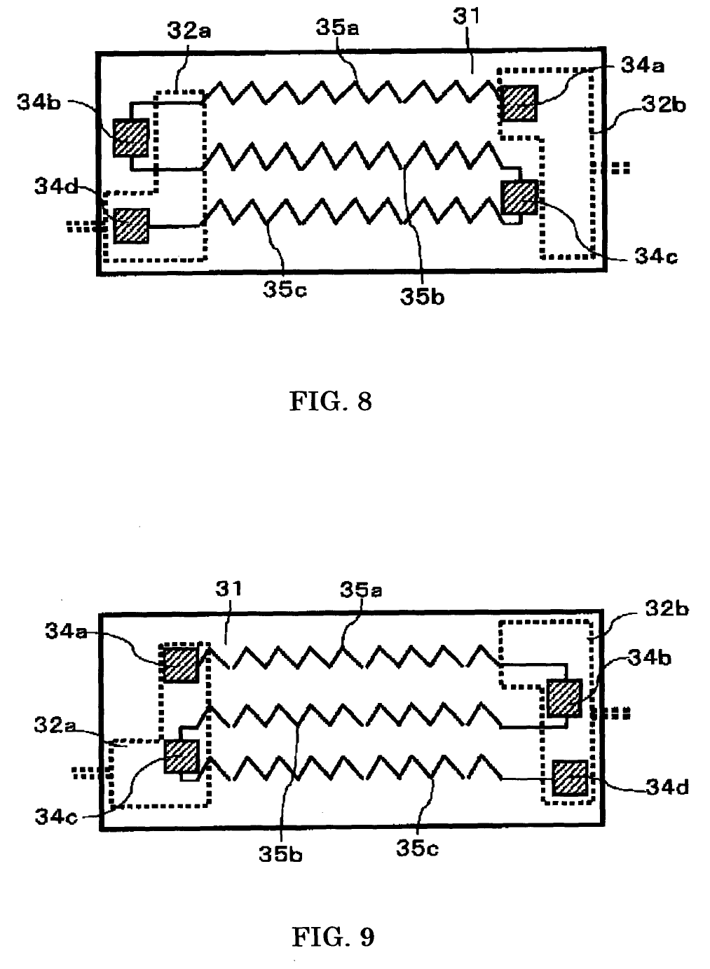

FIG. 8 shows the connection state in which the circuit board 31 is mounted to the power supply units (only the terminals are shown) using a first mounting orientation. The contact points 34a, 34b, 34c, and 34d on the circuit board 31 and the terminals 32a and 32b are connected by connecting the circuit board 31 to the powers supply units in this embodiment as well.

The terminal 32a has an L-shaped configuration, and is connected to the contact point 34d only. The other terminal 32b also has an L-shaped configuration, and is disposed such that it comes into contact with the contact points in the shorter side area opposite from the terminal 32a. Consequently, the terminal 32b is in contact with the contact point 34a only. Through the connection described above, the heating resistors 35a, 35b and 35c are connected in series.

FIG. 9 shows the connection state using a second mounting orientation. In this state, the circuit board 31 mounted using the first mounting orientation (FIG. 8) is rotated 180° relative to an axis perpendicular to the wiring surface, and is connected to the same power supply units as in FIG. 8. In other words, the circuit board 31 faces the same direction in both connection states, but the connection between the shorter sides of the circuit board 31 and the power supply unit is the opposite in the two states.

When mounted using the second mounting orientation, which is opposite from the first mounting orientation, the terminal 32a comes into contact with the contact points 34a and 34c, and the terminal 32b comes into contact with both contact points 34b and 34d. Through such connection, the heating resistors 35a, 35b and 35c are all connected in parallel.

As described above, by appropriately forming the arrangement of the contact points on the circuit board and the configurations and positions of the terminals on the power supply units, the connection configuration of the three heating resistors can be alternated between a series connection and a parallel connection.

The heating resistors 35a, 35b and 35c each have a 21 Ω resistance in this embodiment. The combined resistance of the heating resistors 35a, 35b and 35c is 63 Ω when they are connected in series (FIG. 8), and 7 Ω when they are connected in parallel (FIG. 9).

Where the power supply is 100V, the heater output combining the heating resistors 35a, 35b and 35c becomes 160W when the first mounting orientation (FIG. 8) is used. The heater output can be increased to 1,430W by using the second mounting orientation (FIG. 9). As described above, two different output specifications can be accommodated in the same way as in the first embodiment by changing the mounting orientation of the circuit board.

(Embodiment 4)

FIGS. 10 and 11 show a fourth embodiment. This embodiment is also capable of changing the resistance by a factor of four or less as in the embodiment 2 described above.

Contact points 44b, 44d and 44f are disposed in one shorter side area of a rectangular circuit board 41. The contact point 44b is located near a corner of the circuit board 41, and the contact point 44d is located such that it is aligned with the contact point 44b along the shorter side. The contact point 44f is located inward along the longer sides such that it is not aligned with the contact points 44b or 44d.

Contact points 44a, 44c and 44e are disposed in the other shorter side area. The contact point 44a is located near a corner close to the same longer side near which the contact point 44b is located. The contact points 44c and 44e are located toward the inside along the longer sides and are aligned with the shorter sides.

The contact points 44a and 44b are connected via a lead wire 46. Heating resistors 45c, 45b and 45a are placed between the contact points 44b and 44c, between the contact points 44c and 44d, and between the contact points 44e and 44f, respectively. Consequently, the heating resistors 45b and 45c and the lead wire 46 are connected in series.

FIG. 10 shows a connection state in which the circuit board 41 is mounted to the power supply units (only the terminals are shown) using a first mounting orientation. The terminal 42a has a letter T configuration, and faces the shorter side area in which the contact points 44b, 44d and 44f are located. Of these contact points, the terminal 42a is connected to the contact points 44d and 44f.

The other terminal 42b has an inverted letter C configuration, and is located such that it comes into contact with the shorter side area in which the contact points 44a, 44c and 44e are located. Of these contact points, the terminal 42b is connected to the contact points 44a and 44e. Here, the heating resistors 45b and 45c are connected in series, and the heating resistor 45a is connected such that it is connected in parallel therewith.

FIG. 11 shows the connection state using a second mounting orientation. In this connection state, the circuit board 41 mounted using the first mounting orientation shown in FIG. 10 is rotated 180° relative to an axis perpendicular to the wiring surface, and is connected to the same power supply units as in FIG. 10. In other words, the circuit board 41 faces the same direction in both connection states, but the connection between the shorter sides of the circuit board 41 and the power supply units is the opposite in the two states.

In the connection state using the second mounting orientation, the terminal 42a is in contact with the contact points 44c and 44e. On the other hand, the terminal 42b is in contact with all of the contact points 44b, 44d and 44f in the shorter side area with which it is in contact. Through such connection, all of the heating resistors 45a, 45b and 45c are connected in parallel.

As described above, by appropriately setting the arrangement of the contact points on the circuit board and the configurations and positions of the terminals on the power supply units, the connection configuration of some heating resistors can be alternated between series connection and parallel connection.

In this embodiment, because the resistance of the heating resistor 45a is 20 Ω and the resistances of the heating resistors 45b and 45c are both 33 Ω, the combined resistance for the entire circuit board is 15.3 Ω when the first mounting orientation (FIG. 10) is used, and 9 Ω when the second mounting orientation (FIG. 11) is used.

Where the power supply is 100V, the heater output combining the heating resistors 45a, 45b and 45c becomes 650W when the first mounting orientation (FIG. 10) is used. The heater output can be increased to 1,100W by using the second mounting orientation (FIG. 11). As described above, two different specifications can be accommodated by changing the mounting orientation of the circuit board.

As described above, this embodiment constitutes a part in which the resistance can be increased by a factor of four by alternating the connection between two heating resistors between series a connection and a parallel connection, as well as another heating resistor that is connected to the former resistors in parallel. Consequently, various combinations of variable resistances can be obtained.

(Embodiment 5)

This embodiment is an example in which contact points are disposed near only one side of the circuit board. In this case, only one power supply unit with terminals that supply power to the circuit board is required, and the mounting orientation can be changed by flipping over the circuit board by 180° relative to an axis parallel thereto. In other words, connection of the circuit board to the power supply unit can be effected by reversing the circuit board.

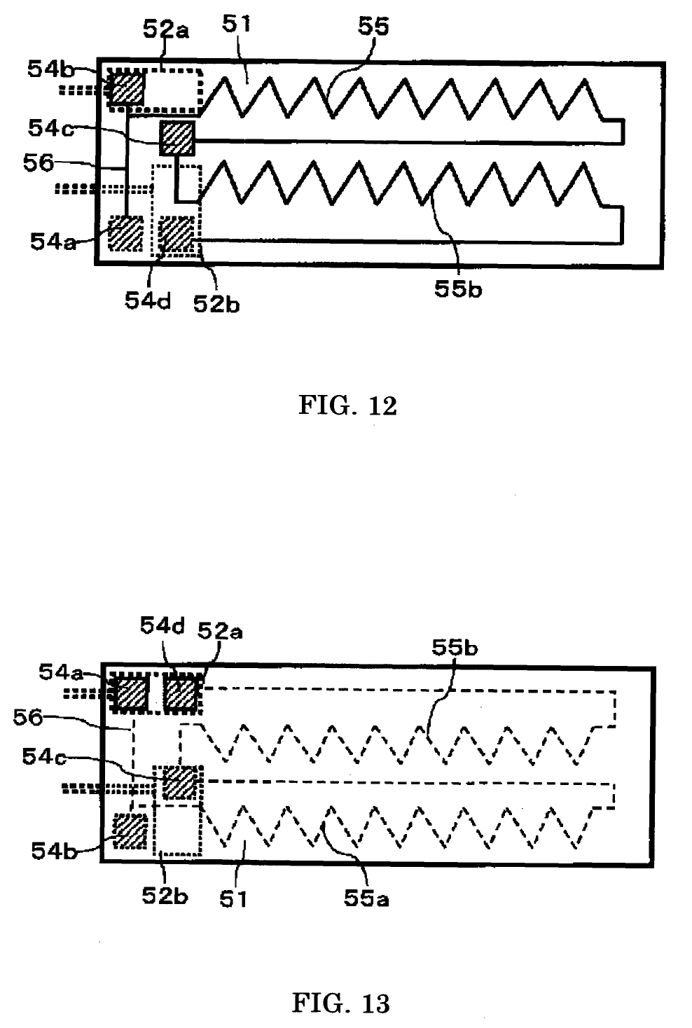

FIG. 12 shows a connection state of this embodiment using a first mounting orientation. Contact points 54a, 54b, 54c and 54d are disposed in one shorter side area of a rectangular circuit board 51. The contact points 54a and 54b are located near either corner of the circuit board 51. The contact point 54d is located such that it is aligned with the contact point 54a along the longer sides of the circuit board 51. The contact point 54c is located near the center of the shorter side such that it is aligned with the contact point 54d along the shorter side. In FIG. 12, the contact points 54b and 54c are located such that they come into contact with the terminals via the front side of the circuit board 51 while the contact points 54a and 54d are located such that they come into contact with the terminals via the back side of the circuit board 51.

The contact points 54a and 54b are connected via a lead wire 56. A heating resistor 55a is disposed such that it runs from the lead wire 56 toward the other shorter side of the circuit board 51 after passing between the contact points 54b and 54c. The end wire of the resistor returns to the shorter side area in which the contact points are disposed and is connected to the contact point 54c. The heating resistor 55b is disposed such that it extends from the contact point 54c toward the shorter side of the circuit board 51 opposite from the shorter side near which such contact point is disposed. The heating resistor 55b reverses direction and is connected at the end thereof to the contact point 54d.

When the circuit board 51 is connected to the power supply unit, the contact points on the circuit board 51 come into contact with the terminals 52a and 52b on the power supply unit. The terminal 52a has a rectangular configuration that extends along the longer sides of the circuit board 51, and is disposed such that it comes into contact with the contact points on the front side of the circuit board 51 shown in FIG. 12. On the other hand, the terminal 52b has a rectangular configuration that extends along the shorter sides of the circuit board 51, and comes into contact with the contact points on the back side of the circuit board 51.

In the connection state using the first mounting orientation shown in FIG. 12, the terminal 52a is connected to the contact point 54b on the front side of the circuit board 51, and the terminal 52b is connected with the contact point 54d on the back side of the circuit board 51. Consequently, the heating resistors 55a and 55b are connected in series.

FIG. 13 shows the connection state using a second mounting orientation. In this state, the circuit board 51 is rotated by 180° relative to an axis that runs along the longer sides from the state shown in FIG. 12, and the circuit board 51 is connected to the power supply unit shown in FIG. 12. Here, the contact points 54a and 54d, which are aligned along a longer side, are both connected to the terminal 52a. The terminal 52b and the contact point 54c are also connected. Consequently, the heating resistors 55a and 55b are connected in parallel.

In this embodiment, because each heating resistor has a resistance of 20 Ω, the combined resistance for the entire circuit board is 40 Ω when the circuit board is mounted using the first mounting orientation (FIG. 12) in which the heating resistors 55a and 55b are connected in series, and is 10 Ω when the circuit board is mounted using the second mounting orientation (FIG. 13) in which the heating resistors 55a and 55b are connected in parallel. Where the power supply is 100V, if the first mounting orientation is used (FIG. 12), the heater output combining the heating resistors 55a and 55b becomes 250W, and if the second mounting orientation is used (FIG. 13), the heater output becomes 1,000W. As described above, two different specifications can be accommodated by changing the mounting orientation of the circuit board. In addition, because a power supply unit is used for only one side of the board, less space is required.

(Embodiment 6)

The sixth embodiment comprises a fixing device using the induction heating method in which the present invention is applied. It is described below with reference to the drawings.

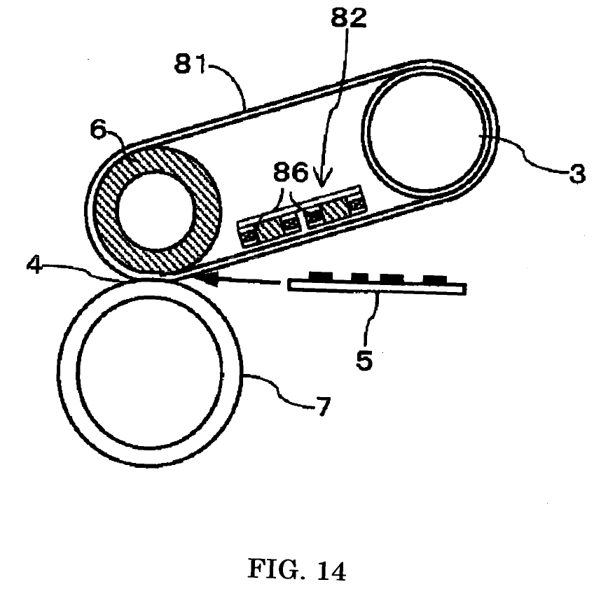

FIG. 14 is a schematic diagram showing the construction of an induction heating-type fixing device. A fixing belt 81 is wrapped around a tension roller 3 and a drive roller 6 connected to a motor not shown, and the drive roller 6 presses against a pressure roller 7 via the fixing belt 81. For these components, the same materials used in the belt-type fixing device incorporating heating resistors and shown in FIG. 1 may be used.

A coil assembly 82 comprising a circuit board is disposed inside the fixing belt 81. The coil assembly 82 comprises a core that forms a closed magnetic path to eliminate leakage flux from the board, as well as electric wiring including a coil 83 that is coiled around the core and performs induction heating of the fixing belt 81. This coil assembly 82 is disposed such that it is separated from the inner surface of the fixing belt 81 by a certain distance. However, it may also be disposed in contact with the belt inner surface via an insulation material. The coil assembly 82 is connected to and secured to power supply units disposed in the fixing device structure in the same manner as shown in FIG. 3. These power supply units include terminals to supply power to the coil assembly 82.

In this embodiment, the fixing belt 81 is heated based on the following principle. A magnetic flux is first generated when the electromagnetic induction coil is energized, whereupon an induction eddy current that leads to generation of a magnetic flux opposing the first magnetic flux occurs in the fixing belt, which comprises a conductive material. This induction eddy current is converted into Joule heat by the resistivity of the fixing belt 81, which is then heated.

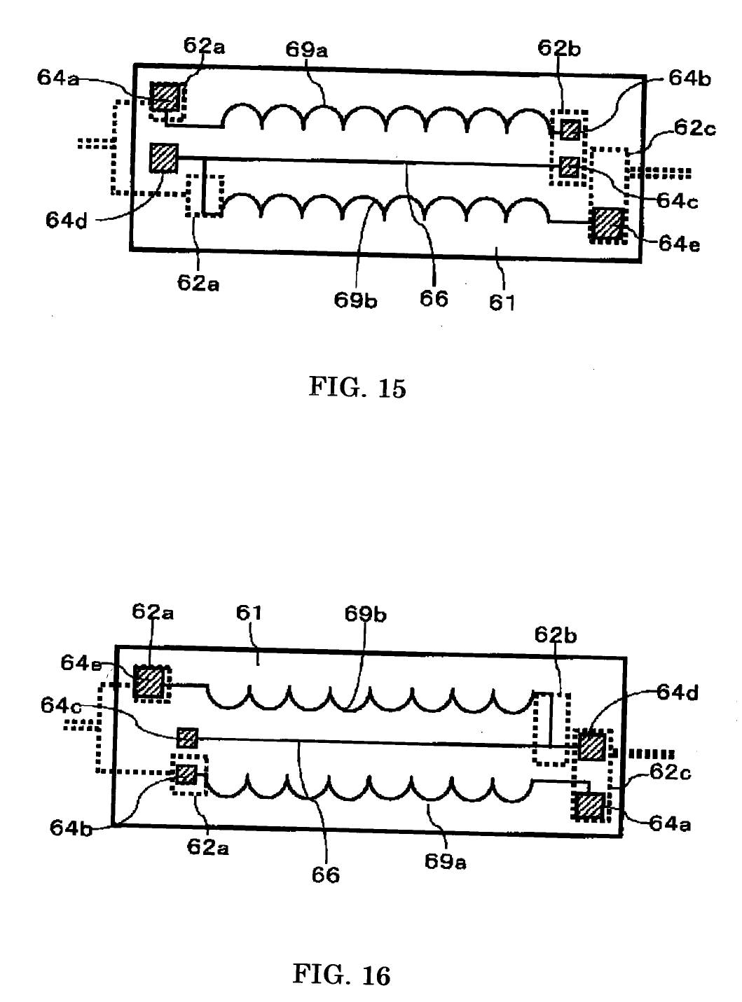

FIGS. 15 and 16 show the orientations by which the circuit board electric wiring, which comprises the coil assembly 82 shown in FIG. 14, is connected to the power supply units. The core is not shown in FIGS. 15 and 16.

Contact points 64a and 64d are disposed in one shorter side area of a rectangular circuit board 61. The contact point 64a is located near a corner of the circuit board 61, and the contact point 64d is located such that it is aligned with the contact point 64a along the shorter side.

Contact points 64b, 64c and 64e are disposed in the other shorter side area. The contact point 64e is located near the corner diagonal from the contact point 64a on the circuit board 61. The contact points 64b and 64c are aligned near the center along the shorter side, and are arranged such that they are not aligned with the contact point 64e.

An electromagnetic induction coil 69a is disposed between the contact points 64a and 64b, and a lead wire 66 is disposed between the contact points 64c and 64d. Furthermore, an electromagnetic induction coil 69b is disposed between the lead wire 66 and the contact point 64e.

FIG. 15 shows the connection state in which the circuit board is mounted to the power supply units (only the terminals are shown) using a first mounting orientation. The contact points on the circuit board 61 and the terminals 62a, 62b and 62c of the power supply units become connected when the circuit board 61 is connected to the power supply units.

The terminal 62a for power supply comprises two linked terminals, one located at a position at which it faces a contact point near a corner of the circuit board 61 and the other located at a position at which it faces a contact point located near the center of a shorter side.

The terminal 62c has a rectangular configuration that extends along the shorter sides of the circuit board 61, and is disposed such that it connects to the shorter side area on the circuit board 61 that is opposite from the terminal 62a.

On the other hand, the terminal 62b is a terminal to connect the contact points, and is disposed near the same shorter side close to which the contact point 62c is located such that it comes into contact with contact points that are located toward the inside from the terminal 62c along the longer sides of the circuit board 61.

In the connection state using the first mounting orientation shown in FIG. 15, the terminal 62a is in contact with the contact point 64a, and the terminal 62c is in contact with the contact point 64e. The terminal 62b connects the contact point 64b, which is a contact point at the end of the electromagnetic induction coil 69a, and the contact point 64c, which is a contact point at the end of the lead wire 66. Through the connection described above, the electromagnetic induction coils 69a and 69b are connected in series.

FIG. 16 shows the connection state using a second mounting orientation. In this connection state, the circuit board 61 mounted using the first mounting orientation shown in FIG. 15 is rotated by 180° relative to an axis perpendicular to the wiring surface, and the circuit board 61 is connected to the same power supply units as those shown in FIG. 16. In other words, the circuit board 61 faces the same direction in both connection states, but the connection between the circuit board 61 and the power supply units is the opposite in the two states.

The terminal 62a is in contact with the contact points 64e and 64b. At the same time, the terminal 62c is in contact with the contact points 64a and 64d. The terminal 62b has no contact points in the area that it faces, and therefore is not in contact with any contact points. Through such connection, the electromagnetic induction coils 69a and 69b are connected in parallel.

As described above, by appropriately setting the arrangement of the contact points on the circuit board and the configurations and positions of the terminals on the power supply units, the connection configuration of the electromagnetic induction coils 69a and 69b can be alternated between a series connection and a parallel connection by changing the mounting orientation of the circuit board.

In the connection state using the first mounting orientation of any of the embodiments 1 through 4, the same-side ends of the two heating resistors parallel to each other are connected, creating a series connection, such that the current flows in opposite directions to the two heating resistors. However, in the connection state using the first mounting orientation in this embodiment, the circuit board is wired such that the current flows in the same direction to the two electromagnetic induction coils, which are connected in series. Such wiring enables the amount of heat generation obtained via series connection or parallel connection to be set in the same manner in this embodiment in any of the embodiments 1 through 5 above, making such setting easy to do.

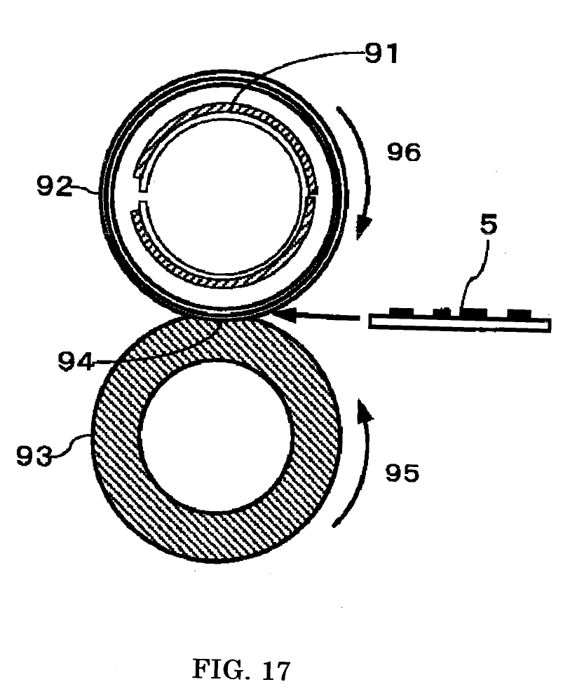

The circuit board having heating resistors or electromagnetic induction coils as the heating elements may be applied not only in the belt-type fixing device shown in FIGS. 1-14, but also in a heat roller-type fixing device shown in FIG. 17.

The fixing device shown in FIG. 17 includes a cylindrical circuit board 91 having heating resistors, and a heat roller 92 is heated from its inner wall based on the heating action of the circuit board.

The heat roller 92 having the heating unit 91 therein is rotatably disposed, and a pressure roller 93 is connected to a motor not shown. When the pressure roller 93 rotates in the direction of the arrow 95 due to driving by the motor, the heat roller 92 rotates accordingly in the direction of the arrow 96. Passing the sheet 5 carrying a toner image through the nip 94 enables the toner to be fused and fixed on the sheet.

Power supply units not shown are disposed at the ends of the cylindrical circuit board 91, and the output may be changed and different power supply voltages can be accommodated in the same manner as in the embodiments 1 through 6 by changing the mounting orientation.

The electric apparatus of the present invention may be applied not only in fixing devices described above but also in various other apparatuses having heating elements, including cooking apparatuses such as electric stoves, water heaters, and toasters, as well as heating apparatuses such as room heaters.

As described above, each embodiment above can output a constant power level from different power supply voltages or output different power levels from the same power supply voltage simply by changing the mounting orientation of a signal circuit board. Therefore, output of a constant power level from different power supply voltages and output of different power levels from the same power supply voltage can be realized easily and inexpensively.

Although the present invention has been fully described by way of examples with reference to the accompanying drawings, it is to be noted that various changes and modifications will be apparent to those skilled in the art. Therefore, unless such changes and modification depart from the scope of the present invention, they should be construed as being included therein.

What is claimed is:

1. An electric apparatus comprising:
a power supply unit that has terminals to supply power to a circuit board; and
a circuit board that can be mounted to said power supply unit using at least two different mounting orientations and can change the current path depending on the orientation with which it is mounted.

2. An electric apparatus according to claim 1, wherein the power consumed by said circuit board can be changed depending on the direction in which it is mounted to said power supply unit.

3. An electric apparatus according to claim 1, wherein the power consumed by said circuit board can be maintained at a constant level by changing the orientation in which said circuit board is mounted to said power supply unit based on the voltage impressed by said power supply unit to said circuit board.

4. An electric apparatus according to claim 1, wherein said circuit board includes a plurality of connection points at which said circuit board is connected to said power supply unit, and two circuit elements that are installed between the connection points, such that the connection between the two circuit elements may be switched between series connection and parallel connection by changing the orientation in which said circuit board is mounted to said power supply unit.

5. An electric apparatus according to claim 4, wherein said circuit elements include a heating resistor.

6. An electric apparatus according to claim 4, wherein said circuit elements include an electromagnetic induction coil

7. An electric apparatus according to claim 1, wherein said circuit board is mountable to said power supply unit in two different orientations whereby one such orientation has a 180° rotational relationship to the other orientation, such orientation being obtained by rotating the circuit board relative to an axis perpendicular to the surface thereof.

8. An electric apparatus according to claim 1, wherein said circuit board is mountable to said power supply unit in two different orientations whereby one such orientation has a 180° rotational relationship to the other orientation, such orientation being obtained by rotating the circuit board relative to an axis parallel to the surface thereof.

9. A heating device comprising:
a power supply unit that has terminals for supplying power to a circuit board; and
a circuit board that has a heater and that can be mounted to the power supply unit in at least two different orientations such that the current path to the heater can be changed depending on the mounting orientation.

10. A heating device according to claim 9, wherein the output of the heater can be changed depending on the direction in which it is mounted to said power supply unit.

11. A heating device according to claim 9, wherein the output of the heater can be maintained at a constant level by changing the orientation in which said circuit board is mounted to said power supply unit based on the voltage impressed by said power supply unit to said circuit board.

12. A heating device according to claim 9, wherein said heater includes two heating elements, such that the connection between the two heating elements may be switched between series connection and parallel connection by changing the orientation in which said circuit board is mounted to said power supply unit.

13. An image forming apparatus comprising:
an image forming system that forms toner images on recording sheets; and
a fixing device that heats and fuses each toner image formed on a sheet by the image forming system,
wherein the fixing device includes a power supply unit that has terminals for supplying power to a circuit board, and a circuit board that has a heater and that can be mounted to the power supply unit in at least two different orientations such that the current path to the heater can be changed depending on the mounting orientation.

14. An image forming apparatus according to claim 13, wherein the output of the heater can be changed depending on the direction in which it is mounted to said power supply unit.

15. An image forming apparatus according to claim 13, wherein the output of the heater can be maintained at a constant level by changing the orientation in which said circuit board is mounted to said power supply unit based on the voltage impressed by said power supply unit to said circuit board.

16. An image forming apparatus according to claim 13, wherein said heater includes two heating elements, such that the connection between the two heating elements may be switched between series connection and parallel connection by changing the orientation in which said circuit board is mounted to said power supply unit.
